(19) United States
(12) Patent Application Publication
(10) Pub. No.: US 2008/0291165 A1
(43) Pub. Date: Nov. 27, 2008

(54) COMPUTER MOUSE

(76) Inventor: Carlos de la Fe Dahlin, Stockholm (SE)

Correspondence Address: YOUNG & THOMPSON, 209 Madison Street, Suite 500, ALEXANDRIA, VA, 22314, US

(21) Appl. No.: 11/937,516

(22) Filed: Nov. 9, 2007

(30) Foreign Application Priority Data
Nov. 10, 2006 (SE) 0602397-2

(51) Int. Cl. G06F 3/033

(52) U.S. Cl. 345/163

(57) ABSTRACT

The present invention relates to a computer mouse (1) which, by means of an accelerometer (mouseacc), detects the absolute movement of the mouse (1). The invention enables the movement of the mouse (1) relative to a surface (3) to be calculated by using at least one further accelerometer (fixacc) fixed to the surface (3).

### TECHNICAL FIELD OF THE INVENTION

The present invention relates to a computer mouse whose external shape enables the computer mouse to be moved over a flat surface, the computer mouse comprising at least a first accelerometer whose purpose is to detect the movement of the mouse.

### PRIOR ART

Traditional computer mice 1 employ a detection technique whereby the movement of the surface 3 relative to the computer mouse is detected by an optical arrangement or by recording the movement of a ball. These computer mice must therefore be moved in the plane 3 defined by the surface, which has the disadvantage that such a surface must exist as well as being relatively clean. In the case of ball-based computer mice dirt, for example in the form of hair, may stick to the connection to the ball and prevent it from moving freely, which is a disadvantage. In the case of optical computer mice dirt may accumulate and obscure the translucent elements which constitute the optical arrangement, which is also a disadvantage.

These disadvantages are eliminated, however, by an invention of prior art disclosed in U.S. Pat. No. 4,787,051. The invention relates to a computer mouse which in its outward appearance resembles a traditional computer mouse, but which uses an accelerometer to detect its movements. The technique means that the computer mouse need not be moved in the plane defined by the surface, which in turn means that even if the computer mouse is in and of itself designed to move mainly along the surface, the requirements regarding the evenness and cleanliness of the surface are almost non-existent.

Furthermore, because the technique is totally enclosed inside the computer mouse, the function of the computer mouse is totally insensitive to the accumulation of dirt.
However, a computer mouse which detects its movements by detecting accelerations and which has the appearance of a traditional computer mouse does not automatically provide the same experience and feeling as a traditional computer mouse without modification. The reasons for this are as follows:
1. Traditional computer mice only detect movement when the computer mouse is in contact with the surface, which means that a traditional computer mouse can be lifted from the surface and transferred to another surface position without the cursor moving on the computer screen when this movement is performed. This process is common practice and can be used, for example, when the mouse has reached the edge of a desk and you want to move the mouse in a little on the desk without the cursor moving on the computer screen because of this. A mouse incorporating an accelerometer does not behave in such a manner, however, but instead the mouse detects accelerations even when it is not in contact with the surface, which introduces a new and unfamiliar feature in its use which in all probability is undesirable.
2. When a traditional computer mouse lies on, and still relative to, a desk, for example, no movement of the mouse is recorded even if the desk itself moves, which may be the case if the desk is located in a train or aircraft, for example, or if the desk is exposed to an impact, vibration or shaking. The fact that the traditional mouse only records movement relative to the surface is therefore in some cases, described above, a major advantage which the computer mouse incorporating an accelerometer lacks because it records all accelerations to which the mouse is subjected regardless of whether they are desirable, such as when the mouse is moved by a user relative to a surface, or undesirable, when for example an aircraft accelerates a mouse even if it is at rest relative to the surface. Note that problems arise in the case a mouse which lies, for example, on an accelerating surface even if the mouse is at the same time being moved by a user relative to the surface, since the acceleration of the surface (and also the user of the mouse for that matter) is undesirably added to the movement of the mouse relative to the surface.

### OBJECTS AND FEATURES OF THE INVENTION

A primary object of the present invention is to add to a computer mouse 1, which records accelerations by means of an accelerometer and which is designed to be moved on a flat surface 3, a device that is intended to subtract the movement of the surface from the total movement of the computer mouse (by total is meant relative to the ground). The movement of the mouse relative to the surface is maintained in this manner and a traditional mouse behaviour can be simulated. The device comprises at least one accelerometer, fixacc, which has been fixed relative to the surface, i.e. does not move relative to the surface, a processing unit which subtracts the movement of the surface, detected by fixacc, from the total movement of the mouse, which is detected by the accelerometer housed in the mouse, mouseacc, and a connection between fixacc, mouseacc and the processing unit, so that a system is obtained. The resultant movement that is obtained after the subtraction and is equal to the movement of the mouse relative to the surface guides the cursor on the screen.

### BRIEF DESCRIPTION OF THE DRAWING

Below a preferred embodiment of the invention will be described, reference being made to the accompanying drawing, where:

FIG. 1 shows an arrangement of a portable computer and a computer mouse, said arrangement including accelerometers in accordance with the present invention.

### DESCRIPTION OF A FIRST PREFERRED EMBODIMENT

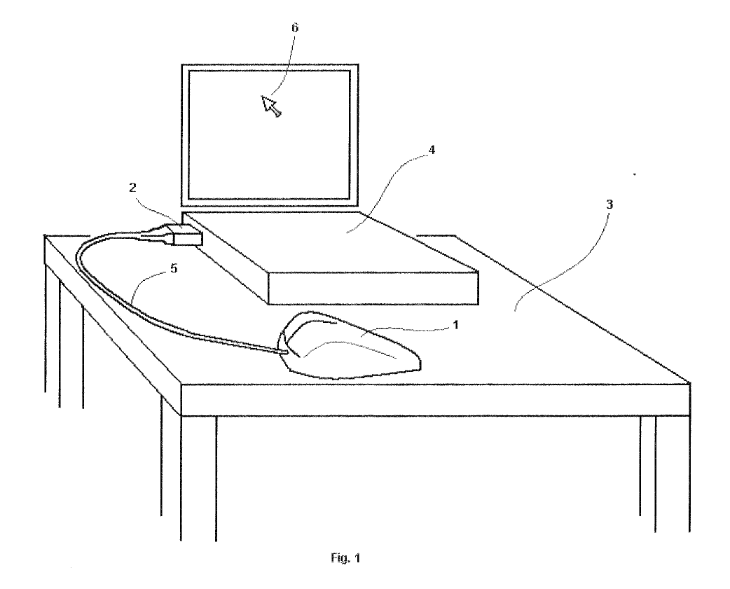

FIG. 1 shows a computer mouse 1 comprising a first accelerometer mouseacc, which has been omitted from the figure, a portable computer 4, a cord head 2, for example of USB type, which is still relative to the portable computer 4, which is still relative to the surface 3, the cord head 2 incorporating a second accelerometer fixacc, which has been omitted from the figure, a cord 5 which connects the first accelerometer mouseacc, the second accelerometer fixacc and the processing unit, and a surface 3 on which lie the mouse 1 and the portable computer 4. The processing unit, which subtracts from the movement detected by the first accelerometer mouseacc the movement detected by the second accelerometer fixacc, for the purpose of allowing the resultant movement, which therefore constitutes the movement of the mouse 1 relative to the surface 3, to guide the cursor 6. The processing unit may be accommodated in the computer mouse 1 or in the cord head 2, or may consist of the processing unit of the portable computer 4.

### DESCRIPTION OF A SECOND PREFERRED EMBODIMENT

This embodiment is identical with the first embodiment apart from the fact that the second accelerometer fixacc is located inside a mobile phone. If the mobile phone that incorporates the second accelerometer fixacc for instance is located in a pocket the following should be considered: The movements of the mouse relative to the surface is normally much larger than the movements of the second accelerometer fixacc relative to the surface. Therefore, the second accelerometer fixacc may be regarded as still relative to the surface. An advantage to have the second accelerometer fixacc in a mobile phone is that it is likely that accelerometers will be provided in mobile phones for other reasons than those of the present invention. This means that the present invention may be realised more easily. If the mobile phone in addition comprises wireless technique, e.g. Bluetooth, and a processing unit this may be used to realise the system.

### DESCRIPTION OF A THIRD PREFERRED EMBODIMENT

This embodiment is identical with the first or second embodiment apart from the fact that the first accelerometer mouseacc is located in a mobile phone. In such a case the mobile phone should have an outer shape that allows it to be displaced over a planar surface. An advantage to locate the first accelerometer mouseacc in a mobile phone is that it is likely that accelerometers will be provided in mobile phones for other reasons than those of the present invention. This means that it is easier to realise the present invention. If the mobile phone in addition comprises wireless technique, e.g. Bluetooth, and a processing unit this may be used to realise the system. The buttons of the mobile phone may be used as mouse buttons.

### Other Aspects

Note that within the scope of the present invention accelerometer refers to any device whose purpose is to detect accelerations. Also note that within the scope of the present invention the second accelerometer fixacc, whose purpose is to detect the accelerations of the surface 3, can be fixed/still in any manner relative to the surface 3, directly in the surface 3 or indirectly in it, for example via a portable computer 4 standing on the surface 3, and is therefore still relative to the surface 3. Note that within the scope of the present invention the connection between the units constituting the system may be of any type, for example one cable 5, a plurality of cables or a form of wireless connection may be used.

In the first embodiment described above a portable computer 4 is used. Within the scope of the present invention any kind of computer may be used, e.g. a stationary computer.

Instead of a computer screen the invention may be used in connection with a television screen, or a film screen/projection screen.

1. A computer mouse (1) whose external shape enables the computer mouse (1) to be moved over a flat surface (3), comprising at least a first accelerometer (mouseacc) whose purpose is to detect the movement of the mouse (1),
characterised in that said computer mouse (1) is arranged to be incorporated in a system comprising at least a second accelerometer (fixacc) that is still relative to the surface (3), a processing unit which calculates the movement of the computer mouse (1) relative to the surface (3) from the signals transmitted by said accelerometers (mouseacc, fixacc), and that this relative movement is taken as a basis for positioning the mouse cursor (6) on a computer screen, a television screen, or a film screen/projection screen.

2. Computer mouse (1) according to claim 1,
characterised in that the processing unit is incorporated in a computer (4).

3. Computer mouse (1) according to claim 1,
characterised in that the processing unit is incorporated in the computer mouse (1) itself.

4. Computer mouse (1) according to claim 1,
characterised in that the computer mouse (1), the computer (4), the processing unit and the accelerometers (mouseacc, fixacc) are communicating via a wireless connection.

5. Computer mouse (1) according to claim 1,
characterised in that the second accelerometer (fixacc) is incorporated in a cordhead (2) of a cord (5) that extends between the computer mouse (1) and a computer (4).

6. Computer mouse (1) according to claim 1,
characterised in that the second accelerometer (fixacc) is incorporated in a plug attached to a computer (4).

7. Computer mouse (1) according to claim 1,
characterised in that the second accelerometer (fixacc) is incorporated in a computer (4).

8. Computer mouse (1) according to claim 1,
characterised in that the second accelerometer (fixacc) is incorporated within a mobile phone.

9. Computer mouse (1) according to claim 1,
characterised in that the computer mouse (1) is a mobile phone that incorporates the first accelerometer (mouseacc).

10. Computer mouse (1) according to claim 2,
characterised in that the second accelerometer (fixacc) is incorporated in a cordhead (2) of a cord (5) that extends between the computer mouse (1) and a computer (4).

11. Computer mouse (1) according to claim 3,
characterised in that the second accelerometer (fixacc) is incorporated in a cordhead (2) of a cord (5) that extends between the computer mouse (1) and a computer (4).

12. Computer mouse (1) according to claim 2,
characterized in that the second accelerometer (fixacc) is incorporated in a plug attached to a computer (4).

13. Computer mouse (1) according to claim 2,
characterised in that the second accelerometer (fixacc) is incorporated in a computer (4).

14. Computer mouse (1) according to claim 2,
characterised in that the second accelerometer (fixacc) is incorporated within a mobile phone.

15. Computer mouse (1) according to claim 2,
characterised in that the computer mouse (1) is a mobile phone that incorporates the first accelerometer (mouseacc).

16. Computer mouse (1) according to claim 3,
characterised in that the second accelerometer (fixacc) is incorporated in a plug attached to a computer (4).

17. Computer mouse (1) according to claim 3,
characterised in that the second accelerometer (fixacc) is incorporated in a computer (4).

18. Computer mouse (1) according to claim 3,
characterised in that the second accelerometer (fixacc) is incorporated within a mobile phone.

19. Computer mouse (1) according to claim 3,
characterised in that the computer mouse (1) is a mobile phone that incorporates the first accelerometer (mouseacc).
